(19) United States
(12) Patent Application Publication
(10) Pub. No.: US 2009/0067962 A1
(43) Pub. Date: Mar. 12, 2009

(54) Vehicle cart transfer system

(75) Inventor: Sung J. Lee, Ulsan (KR)

Correspondence Address: Edwards Angell Palmer & Dodge LLP, P.O. Box 55874, Boston, MA, 02205, US

(73) Assignee: Hyundai Motor Company, Seoul (KR)

(21) Appl. No.: 12/006,184

(22) Filed: Dec. 31, 2007

(30) Foreign Application Priority Data
Sep. 12, 2007 (KR) 10-2007-0092680

(51) Int. Cl. B65G 69/26; B65G 69/24

(52) U.S. Cl. 414/331.11

(57) ABSTRACT

The present invention provides a vehicle cart transfer system including a plurality of cart transfer devices arranged in parallel, each of which includes a turntable adapted to received a cart placed thereon, a turntable driving unit for rotating the turntable, and a turntable lifting unit for lifting the turntable up and down, wherein the plurality of cart transfer devices rotate the turntables in the opposite direction so that two turntables become close to each other during transfer of the carts. Accordingly, the turntables are rotated in the opposite direction to be adjacent to each other so that the cart loaded on one of the turntables is directly transferred to the other turntable, thus effectively transferring the cart without a conveyor.

### CROSS-REFERENCE TO RELATED APPLICATION

This application claims under 35 U.S.C. §119(a) on Korean Patent Application No. 10-2007-0092680, filed on Sep. 12, 2007, the entire contents of which are incorporated herein by reference.

### BACKGROUND

(a) Technical Field

The present invention relates to a vehicle cart transfer system. More particularly, the present invention relates to a vehicle cart transfer system comprising a plurality of cart transfer devices, each having respective turn tables adapted to receive a vehicle cart and turn so as to transfer the vehicle cart from one device to the other device.

(b) Background Art

A vehicle is an assembly of a plurality of components. A production line on which the vehicle is assembled includes a plurality of assembly lines arranged in parallel. Various components are assembled to a vehicle body loaded on a vehicle cart, and the vehicle cart is transferred to the plurality of assembly lines.

Like this, to assemble the components to a vehicle body, a vehicle loaded cart and/or a vehicle unloaded cart are transferred from one assembly line to the other line.

Conventionally, a vehicle cart in one line is transferred to the next line along a number of rails placed on the bottom of the assembly lines or it is transferred using a forklift. Otherwise, it is lifted up by a lift and placed on a conveyor to be transferred to a upper part of the next line, and is then received by a drop lift on the next line and moved down.

However, the conventional vehicle cart transfer systems have the following drawbacks. First, in case of the rails provided among assembly lines, a safety accident may occur due to the rails. Moreover, in case of the forklift, the vehicle cart may be contaminated by foreign substances during the transfer, which may stop the production line. Furthermore, in case of the lift, conveyor and drop lift, it increases costs for installing the conveyor.

The information disclosed in this Background section is only for enhancement of understanding of the background of the invention and should not be taken as an acknowledgement or any form of suggestion that this information forms the prior art that is already known to a person skilled in the art.

### SUMMARY OF THE DISCLOSURE

Accordingly, the present invention has been made in an effort to solve the above-described drawbacks and one object of the present invention is to provide a vehicle cart transfer system with a simpler structure.

In one aspect, the present invention provides a vehicle cart transfer system comprising a plurality cart transfer devices arranged in parallel. In particular, the vehicle cart transfer system includes a first cart transfer device which includes a turntable adapted to be able to receive a cart thereon, a turntable driving unit for rotating the turntable, and a turntable lifting unit for lifting the turntable up and down. The system also includes a second cart transfer device arranged in parallel with the first cart transfer device, which includes a turntable adapted to be able to receive a cart thereon, a turntable driving unit for rotating the turntable, and a turntable lifting unit for lifting the turntable up and down. The first and second cart transfer devices rotate the respective turntables so as to become close to each other during transfer of the carts.

In a preferred embodiment of the present invention, each of the turntables comprises a turntable main body and an idle roller provided on the turntable main body for supporting a lower part of the cart. Preferably, each of the turntables may further comprise a cart driving roller connected to the turntable main body for pushing the cart in and out of a upper part of the turntable main body. Also preferably, each of the turntables may further comprise a cart entrance detecting sensor for detecting whether or not the cart is present.

In another preferred embodiment of the present invention, each of the turntables further comprises a cart stopper for preventing the cart from entering beyond a predetermined limit.

In still another preferred embodiment of the present invention, each of the turntables further comprises a cart stop detecting sensor for detecting the entrance of the cart.

In a further preferred embodiment of the present invention, each of the turntables is arranged eccentrically with respect to the rotation center of the respective turntable lifting unit.

In yet a further preferred embodiment of the present invention, each of the turntable driving units comprises a streamlined running rail, a running wheel running along the running rail and connected to the turntable, and a motor for rotating the running wheel.

In a still further preferred embodiment of the present invention, each of the first and second cart transfer devices further comprises a cart rotation detecting sensor for detecting the rotation of the cart.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like.

Other aspects of the invention are discussed infra.

### BRIEF DESCRIPTION OF THE DRAWINGS

FIG. 1 is a schematic plan view of a vehicle cart transfer system in accordance with a preferred embodiment of the present invention;

FIG. 2 is a cross-sectional view taken along line A-A of FIG. 2;

FIG. 3 is a plan view of the vehicle cart transfer system in accordance with a preferred embodiment of the present invention;

FIG. 4 is a plan view of the vehicle cart transfer system of FIG. 3 after a 90° counterclockwise rotation is made;

FIG. 5 is a perspective view of the vehicle cart transfer system in accordance with a preferred embodiment of the present invention; and

FIG. 6 is diagrams illustrating the operation of the vehicle cart transfer system in accordance with the present invention.

### DETAILED DESCRIPTION

Reference will now be made in detail to the preferred embodiment of the present invention, examples of which are illustrated in the drawings attached hereinafter, wherein like reference numerals refer to like elements throughout. The embodiments are described below so as to explain the present invention by referring to the figures.

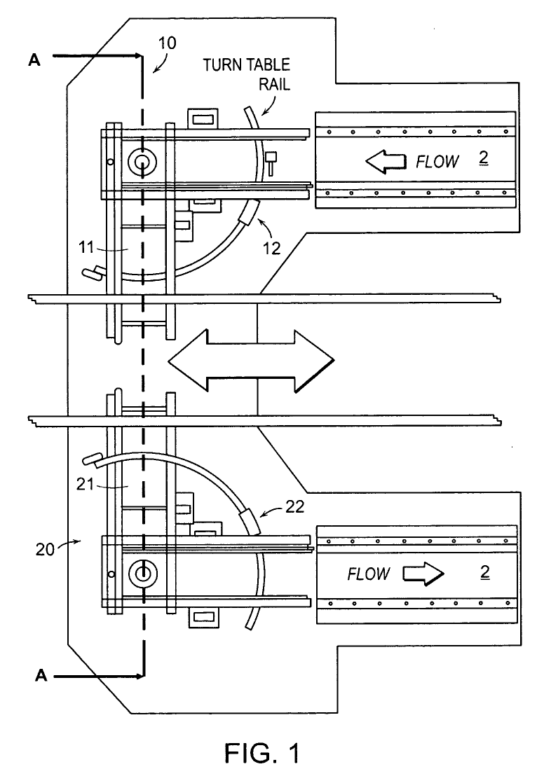

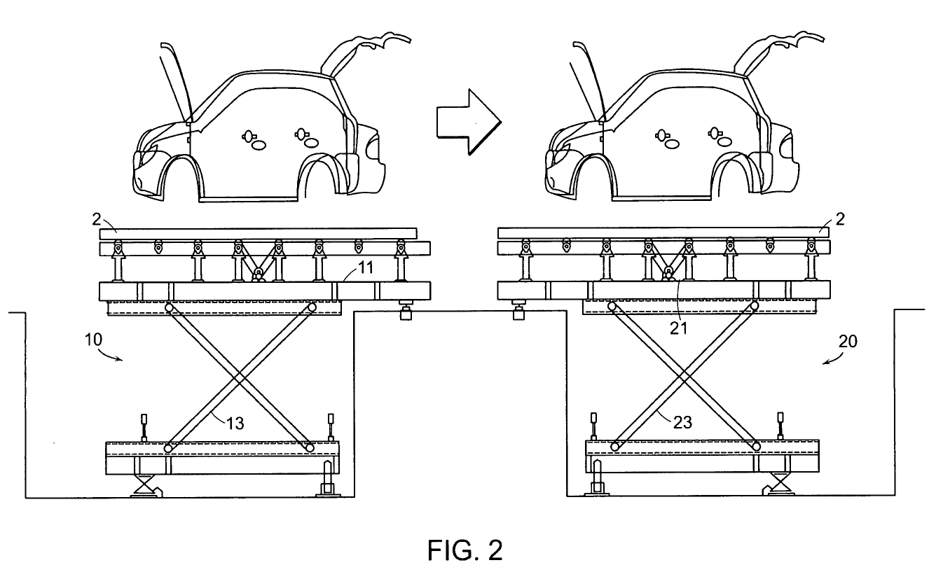

FIG. 1 is a schematic plan view of a vehicle cart transfer system in accordance with a preferred embodiment of the present invention, and FIG. 2 is a cross-sectional view taken along line A-A of FIG. 2.

As shown in FIGS. 1 and 2, in the vehicle cart transfer system in accordance with the present invention, a plurality of cart transfer devices 10 and 20 for transferring a cart 2 is arranged in parallel.

The plurality of cart transfer devices 10 and 20 have the same structure, and each of them includes a turntable 11 or 21 adapted to receive the cart thereon, a turntable driving unit 12 or 22 for rotating the turntable, and a turntable lifting unit 13 or 23 for lifting the turntable 11 or 21 up and down.

The plurality of cart transfer devices 10 and 20 rotate the turntables 11 and 21 in the opposite direction so that the turntables 11 and 21 become close to each other during the transfer of the carts 2.

That is, as shown in FIG. 1, the cart transfer device 10 provided on a transfer line on which the cart is transferred (hereinafter referred to as the first cart transfer device) rotates the turntable 11 about 90° in the clockwise direction toward the cart transfer device 20 provided on the next transfer line (hereinafter referred to as the second cart transfer device). Contrarily, the second cart transfer device 20 rotates the turntable 21 about 90° in the counterclockwise direction toward the cart transfer device 10 to receive the cart 2.

Next, the structure of the cart transfer devices 10 and 20 will be described in detail with reference to the accompanying drawings.

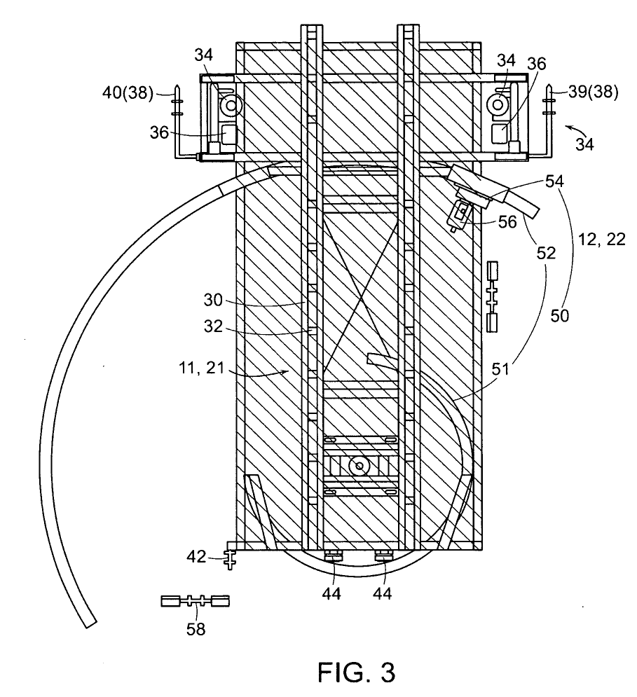

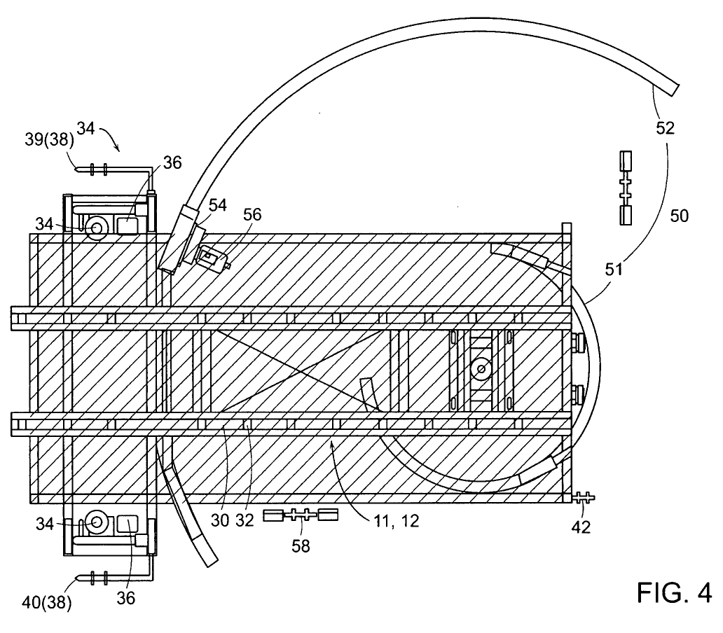

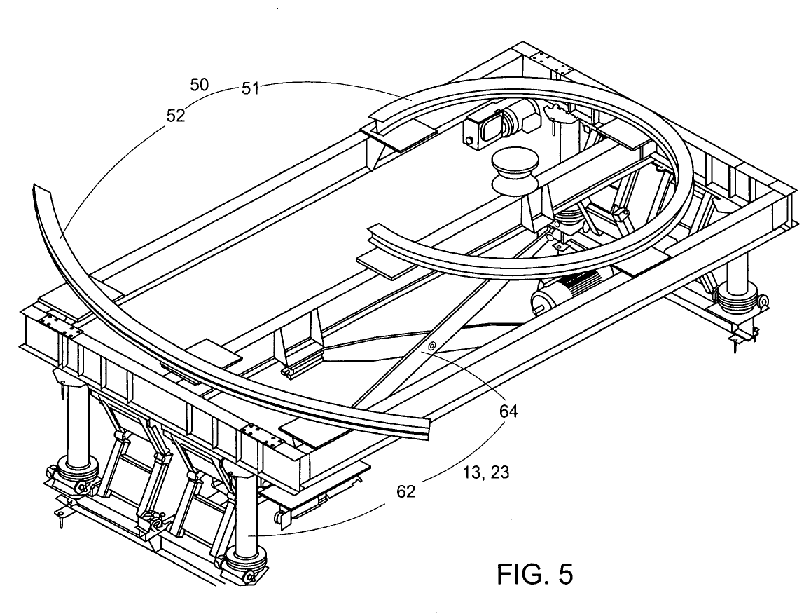

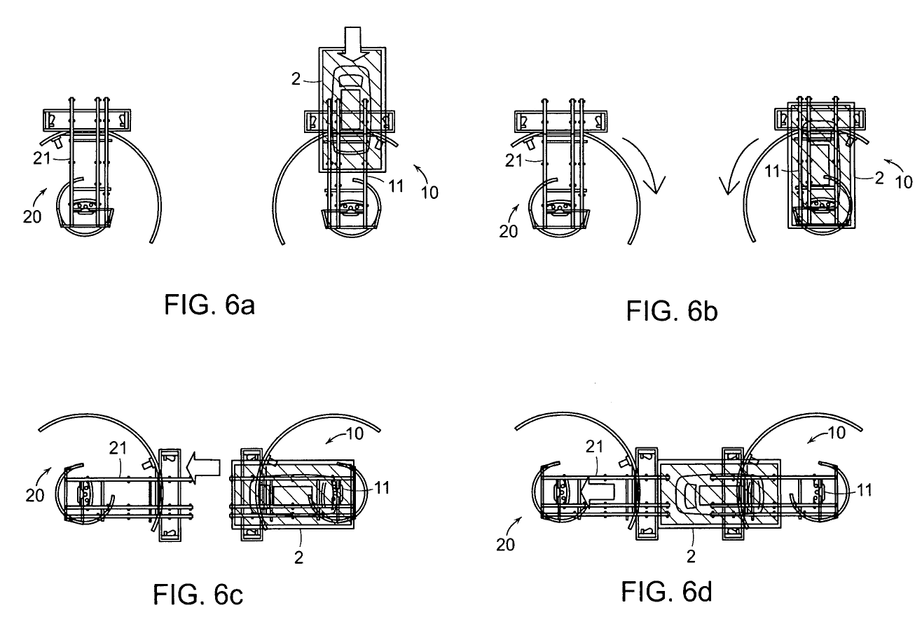

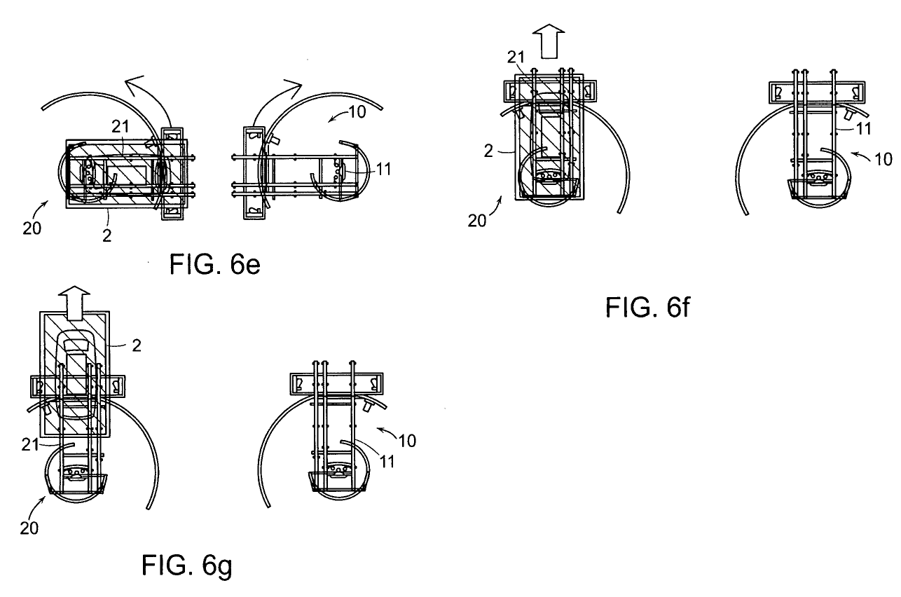

FIG. 3 is a plan view of the vehicle cart transfer system in accordance with a preferred embodiment of the present invention, FIG. 4 is a plan view of the vehicle cart transfer system of FIG. 3 after a 90° counterclockwise rotation is made, FIG. 5 is a perspective view of the vehicle cart transfer system in accordance with a preferred embodiment of the present invention, and FIG. 6 is diagrams illustrating the operation of the vehicle cart transfer system in accordance with a preferred embodiment of the present invention.

Each of the turntables 11 and 21 includes a turntable main body 30 and an idle roller 32 provided on the turntable main body 30 for supporting a lower portion of the cart 2.

The turntable main body 30 is rotated by each of the turntable driving units 12 and 22 and lifted up and down by each of the turntable lifting units 13 and 23. The turntable main body 30 is formed with a rectangular shape in the transfer direction of the respective lines and arranged eccentrically to the center of the turntable lifting units 13 and 23.

The idle roller 32 is provided on the turntable main body 30 so that the cart 2 slidably moves on the turntable main body 30.

A plurality of idle rollers 32 are arranged in the longitudinal direction of the turntable main body 30 as well as in the transverse direction of the turntable main body 30 so as to stably support both sides of the cart 2.

Meanwhile, each of the turntables 11 and 21 includes a cart driving roller 34 connected to the turntable main body 30 for pushing the cart 2 in and out of a upper part of the turntable main body 30, and a driving motor 35 for rotating the cart driving roller 34.

The cart driving roller 34 is provided on both sides of an end of the turntables 11 and 21. When the cart 2 is entered between the cart driving rollers 34, the cart driving rollers 34 come in close contact with the lateral sides of the cart, thus pushing the cart 2 into the end portion.

Each of the turntables 11 and 21 further includes a cart entrance detecting sensor 38 for detecting whether or not the cart 2 is present. The cart entrance detecting sensor 38 is a photosensor including a light emitting portion 39 installed at the left or the right of the turntable main body 30, and a light receiving portion 40 installed at a position opposite to the light emitting portion 39 to receive the light of the light emitting portion 39 when the cart 2 is not entered.

Each of the turntables 11 and 21 further includes a cart stop detecting sensor 42 for detecting the entrance of the cart 2. The cart stop detecting sensor 42 is installed at a position opposite to the cart entrance detecting sensor 38 on the turntable main body 30. When the cart stop detecting sensor 42 detects the approach of the cart 2, the driving motor 36 is stopped so that the cart driving roller 34 is no longer rotated, thus completing the entrance of the cart 2.

Meanwhile, each of the turntables 11 and 21 further includes a cart stopper 44 by which the cart is stopped, thus preventing the cart 2 from being deeply entered, i.e., being entered beyond a predetermined limit. The cart stopper 44 is a mechanical safety device for preventing the cart 2 from being deeply entered and stops the leading end of the cart 2 in the longitudinal direction of the cart 2.

Each of the turntable driving units 12 further includes a streamlined running rail 50, a plurality of running wheels 54 running along the running rail 50 and connected to the turntables 11 and 21, and a motor 56 for rotating the running wheels 54.

The plurality of running wheels 50 are fixedly mounted on the top surface of the turntable lifting units 13 and 23 to stably support the turntables 11 and 21.

The running rail 50 includes an inner rail 51 positioned adjacent to the rotation center of the turntables 11 and 21 and an outer 52 rail having a curvature greater than that of the inner rail 51.

The running wheels 54 substantially rotate the turntables 11 and 21 and are formed so as not to be separated from the running rail 50.

The motor 56 is mounted on the turntables 11 and 21 to rotate the running wheels 54 and rotated together with the turntables 11 and 21.

Meanwhile, each of the plurality of cart transfer devices 10 and 20 includes a cart rotation detecting sensor 58 for detecting the rotation of the cart 2. When the cart rotation detecting sensor 58 detects the cart 20 rotated about 90°, the motor 6 of the turntable driving units 12 and 22 is stopped so that the turntables 11 and 21 are no longer rotated.

As shown in FIG. 5, each of the turntable lifting units 13 and 23 includes a spiral lift 62 and a scissors link 64.

Next, the operation of the vehicle cart transfer system with the above configuration in accordance with the present invention will be described.

First, as shown in FIG. 6A, when the cart 2 on which the vehicle body is loaded is entered into the turntable 11 of the first cart transfer device 10, the cart entrance detecting sensor 38 of the first cart transfer device 10 detects the entrance of the cart 2 and the driving motor 36 of the first cart transfer device 10 operates to rotate the cart driving roller 34 of the first cart transfer device 10. Then, the cart 2 is linearly moved by the cart driving roller 34 of the first cart transfer device 10 along the idle rollers 32 of the first cart transfer device 10 and entered. Subsequently, when the cart entrance detecting sensor 42 of the first cart transfer device 10 detects the approach of the cart 2, the driving motor 36 of the first cart transfer device 10 is stopped so that the cart driving roller 34 is no longer rotated, and thus the entrance of the cart 2 to the upper part of the first cart transfer device 10 is completed.

Subsequently, the turntable lifting unit 13 of the first cart transfer device 10 operates to lift the turntable 11 of the first cart transfer device 10, and the turntable lifting unit 23 of the second cart transfer device 20 operates to lift the turntable 21 of the second cart transfer device 20.

In a state where the turntable 11 of the first cart transfer device 10 and the turntable 21 of the second cart transfer device 20 are lifted up, the cart transfer devices 10 and 20 rotate the turntables 11 and 21 in the opposite direction so that the turntables 11 and 21 become close to each other.

That is, as shown in FIGS. 6B and 6C, the turntable 11 of the first cart transfer device 10 is rotated in the counterclockwise direction and the turntable 21 of the second cart transfer device 20 is rotated in the clockwise direction so that the two turntables 11 and 21 are arranged in a row with a small gap therebetween.

As shown in FIG. 6C, in a state where the turntable 11 of the first cart transfer device 10 and the turntable 21 of the second cart transfer device 20 are arranged in a row, when the driving motor 36 of the first cart transfer device 10 is driven in a direction opposite to that during the entrance of the cart 2 into the first cart transfer device 10, the cart 2 is linearly transferred from the top of the turntable 11 of the first cart transfer device 10 to top of the turntable 21 of the second cart transfer device 20.

During the linear transfer of the cart 2, when the cart 2 is entered into the turntable 22 of the second cart transfer device 20, the cart entrance detecting sensor 38 of the second cart transfer device 20 detects the entrance of the cart 2 and the driving motor 36 of the second cart transfer device 20 operates to rotate the cart driving roller 34 of the second cart transfer device 20. Then, the cart 2 is linearly moved by the cart driving roller 34 of the second cart transfer device 20 as shown in FIGS. 3C, 3D and 3E. Subsequently, when the cart entrance detecting sensor 42 of the second cart transfer device 20 detects the approach of the cart 2, the driving motor 36 of the second cart transfer device 20 is stopped so that the cart driving roller 34 is no longer rotated, and thus the entrance of the cart 2 to the top of the second cart transfer device 20 is completed.

During the transfer of the cart 2, when the cart entrance detecting sensor 38 of the first cart transfer device 10 detects the absence of the cart 2, the driving motor 36 of the first cart transfer device 10 is stopped.

After the cart 2 is moved to the upper part of the second cart transfer device 20 as described above, the turntable 11 of the first cart transfer device 10 and the turntable 21 of the second cart transfer device 20 are rotated in the opposite direction so that the two turntables 11 and 21 get away from each other and then arranged in parallel to each other.

That is, as shown in FIGS. 6E and 6F, the turntable 11 of the first cart transfer device 10 is rotated in the clockwise direction and the turntable 21 of the second cart transfer device 20 is rotated in the counterclockwise direction so that the two turntables 11 and 21 are arranged in parallel to each other.

Next, the turntable lifting unit 13 of the first cart transfer device 10 operates to lift down the turntable 11 of the first cart transfer device 10, and the turntable lifting unit 23 of the second cart transfer device 20 operates to lift down the turntable 21 of the second cart transfer device 20.

Like this, in a state where the turntable 11 of the first cart transfer device 10 and the turntable 21 of the second cart transfer device 20 are lifted down, when the driving motor 36 of the second cart transfer device 20 is driven in a direction opposite to that during the entrance of the cart 2 into the second cart transfer device 20, the cart 2 gets away from the turntable 21 of the second cart transfer device 20 as shown in FIGS. 6F and 6G.

During the transfer of the cart 2, when the cart entrance detecting sensor 38 of the second cart transfer device 20 detects the absence of the cart 2, the driving motor 36 of the second cart transfer device 20 is stopped.

As described above, according to the vehicle cart transfer system of the present invention in which the plurality of cart transfer devices are arranged parallel to each other, the turntables are rotated in the opposite direction to be adjacent to each other so that the cart loaded on the top of one of the turntables is directly transferred to the top of the other turntable. Accordingly, it is possible to effectively transfer the cart without a conveyor.

Moreover, according to the vehicle cart transfer system of the present invention, since the turntable on which the cart is loaded is lifted up and down by a lifting unit, the turntable does not interfere with the passage between the plurality of cart transfer devices or other obstacles.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A vehicle cart transfer system comprising:
a first cart transfer device which includes a turntable adapted to be able to receive a cart thereon, a turntable driving unit for rotating the turntable, and a turntable lifting unit for lifting the turntable up and down,
a second cart transfer device arranged in parallel with the first cart transfer device, which includes a turntable adapted to be able to receive a cart thereon, a turntable driving unit for rotating the turntable, and a turntable lifting unit for lifting the turntable up and down,
wherein the first and second cart transfer devices rotate the respective turntables so as to become close to each other during transfer of the carts.

2. The vehicle cart transfer system of claim 1, wherein each of the turntables comprises a turntable main body and an idle roller provided on the turntable main body for supporting a lower part of the cart.

3. The vehicle cart transfer system of claim 2, wherein each of the turntables further comprises a cart driving roller connected to the turntable main body for pushing the cart in and out of a upper part of the turntable main body.

4. The vehicle cart transfer system of claim 3, wherein each of the turntables further comprises a cart entrance detecting sensor for detecting whether or not the cart is present.

5. The vehicle cart transfer system of claim 1, wherein each of the turntables further comprises a cart stopper for preventing the cart from entering beyond a predetermined limit.

6. The vehicle cart transfer system of claim 1, wherein each of the turntables further comprises a cart stop detecting sensor for detecting the entrance of the cart.

7. The vehicle cart transfer system of claim 1, wherein each of the turntables is arranged eccentrically with respect to the rotation center of the respective turntable lifting unit.

8. The vehicle cart transfer system of claim 1, wherein each of the turntable driving units comprises a streamlined running rail, a running wheel running along the running rail and connected to the turntable, and a motor for rotating the running wheel.

9. The vehicle cart transfer system of claim 1, wherein each of the first and second cart transfer devices further comprises a cart rotation detecting sensor for detecting the rotation of the cart.
